(19) United States
(12) Patent Application Publication
(10) Pub. No.: US 2006/0230118 A1
(43) Pub. Date: Oct. 12, 2006

(54) SHARE MEMORY SERVICE SYSTEM AND METHOD OF WEB SERVICE ORIENTED APPLICATIONS

(75) Inventor: Jung-Sing Jwo, Taichung (TW)

Correspondence Address: NIKOLAI & MERSEREAU, P.A., 900 SECOND AVENUE SOUTH, SUITE 820, MINNEAPOLIS, MN, 55402, US

(73) Assignee: DIGI CHAIN INFORMATION CO., LTD., Taichung City 403 (TW)

(21) Appl. No.: 10/907,696

(22) Filed: Apr. 12, 2005

(51) Int. Cl. G06F 15/167

(52) U.S. Cl. 709/213

(57) ABSTRACT

A share memory service system and method of web service oriented applications, which includes the steps of declaring an object requiring to be shared of a plurality of web services as a shared object, storing the shared object to a shared virtual memory, and providing the shared object of the shared virtual memory for the access of the web services and a plurality of clients. Accordingly, a shared virtual memory may be simulated in any web service oriented applications, and the method of managing the shared virtual memory providing a way for web services of application program to access the shared object directly instead of invoking each other through the external call. Hence the complexity of service oriented applications development may be reduced.

### BACKGROUND OF THE INVENTION

1. Field of Invention

The invention relates to construct the web service oriented applications utilizing the public structure and modularity of web service, and in particular, to the shared object method during dynamic interaction of the web service applications.

2. Related Art

Recently, the efficient resource allocation and information integration of enterprises become factors in judging the competition and superiority, and it results in the employment of the tools such as ERP and SCM for the trend. However, it's the major issues that the information exchange and integration is quiet difficult and complicated since the various and lack of the uniform specification in transaction and work flows. Accordingly, an ideal commercial automation process is constructing a system that forwards the input data and service request issued by customer to a corresponding internal system of the enterprise providing related services automatically, and passing the integrated information to the cooperating firms rapidly.

There exists several XML-based electronic information exchange specifications such as ebXML and biztalk for overcoming the intercommunication problem between the heterogeneous information systems, and the web service concept supporting framework such as .NET proposed by Microsoft, Dynamic web services proposed by IBM, E-speak proposed by HP and ONE proposed by Sun Microsystem is developed in succession. As a result, the web service oriented applications may be the main stream of enterprise application programs and system development. Since the web service is the software component having open and distributed characteristics and constructed over the standard protocols such as the HTTP, XML, SOAP and WSDL, it can be described and implemented in any programming language developing tools and operating systems. In addition, the web service provides a standard remote object call interface and application program coding rule for programmers to access and invoke other web services in the same network in a familiar programming language. Hence, the information exchange and integration of the internal system and the external heterogeneous system may be consistent since the web services utilizing the self-described XML document standard and the SOAP communication protocol.

With reference to FIG. 1A, a web service oriented application 15 applying to a network 11 constructed of several clients 10, where the network 11 can be either an Intranet or an Internet. Moreover, the web services construct in the existing Intranet and Internet, the clients 10 issuing the request and providing many web services 12 utilizes the SOAP 14, and the web service 12 interacting with each other employs SOAP 14. However, it results in the operation-complicating and time-consuming.

With reference to FIG. 1B, the complete graph topology results in the time complexity up to O(N²) since the external call between any two web services 12 becomes required way for data communicating and consistency maintaining, where N indicates the number of web service 12. Thus, the conventional web service oriented applications structure is operation-complicating, time-consuming, costly, and falling short of the electronic enterprise's expectation gradually. Besides, message of the SOAP including more parameters becomes hard to process while more web services 12 is shared, which results in the complexity rising during the enterprise software developing stage.

### SUMMARY OF THE INVENTION

In view of the foregoing, the invention is to provide a share memory service system and method of web service oriented applications applying to a network constructed of a plurality of clients, which have lower time and coding complexity during communication and application program development.

The share memory service method of web service oriented applications of the invention comprises the steps of declaring an object requiring to be shared of every web service as a shared object firstly, storing the shared objects to a shared virtual memory, and then providing the shared objects of the shared virtual memory for the access of the web services and clients. Herein, the objects include the global objects and the local objects, and the shared objects consist of the global shared object and the local shared object.

FIG. 2A and FIG. 2B are a complete and a simplified schematic view showing the web service applications employ the share memory service method according to one preferred embodiment of the present invention respectively. With reference to FIG. 2A, a web service application 20 employs a share memory service 22 applying to either an Intranet or an Internet, and clients 10 issues the request and provides many web services for invoking web services 202 utilizing the SOAP 14. It's noted that the shared objects is managed by the shared memory service 22, and the share memory service 22 processes a request message 204 of accessing the shared object issuing from the web services 202, where the request message 204 includes at least one SOAP. In the other hand, with reference to FIG. 2B, the time complexity is only O(N) since the topology shown in the FIG. 2A is a star, and the operating flow between the web services may be simplified, and thus the development complexity of enterprise application program may be reduced as well.

For the various individual enterprise requirements, industrial characteristics and cooperation modes, a schematic view showing the web service application employs the share memory service method according to another preferred embodiment of the present invention is shown in the FIG. 3. In such embodiment, the share memory service 32 processes a request message 304 of accessing the shared object issuing from web services 302, the web services 302 can also communicate with each other directly without going through the shared memory service 32. However a second request message 305 between the web services 302 includes its own session information. Therefore, the share memory service of the present invention is flexible, practical and adaptable to various client requirements.

### BRIEF DESCRIPTION OF THE DRAWINGS

The invention will become more fully understood from the detailed description given herein below illustration only, and thus is not limitative of the present invention, and wherein:

FIG. 1A is a schematic view showing the conventional web service oriented application;

FIG. 1B is a simplified schematic view showing the conventional web service oriented application;

FIG. 2A is a schematic view showing the web service applications employ the share memory service method according to one preferred embodiment of the present invention;

FIG. 2B is a simplified schematic view showing the web service applications employ the share memory service method according to one preferred embodiment of the present invention;

FIG. 3 is a schematic view showing the web service applications employ the share memory service method according to another preferred embodiment of the present invention; and

FIG. 4 is a block diagram showing the share memory service system according to one preferred embodiment of the present invention.

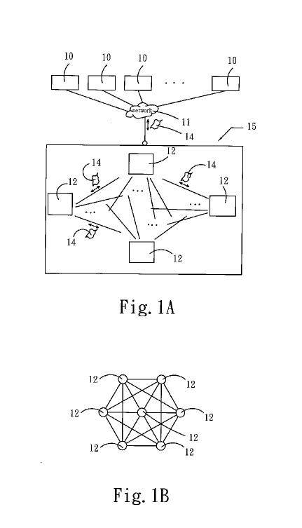

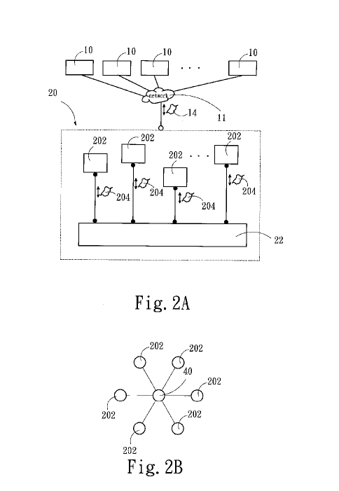

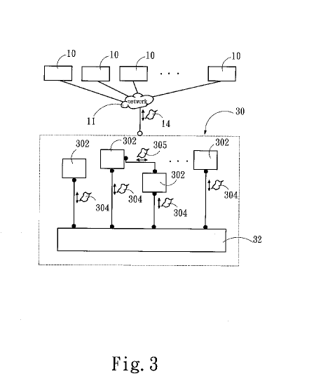

### DETAILED DESCRIPTION OF THE INVENTION

The present invention will be apparent from the following detailed description, which proceeds with reference to the accompanying drawings, wherein the same references relate to the same elements.

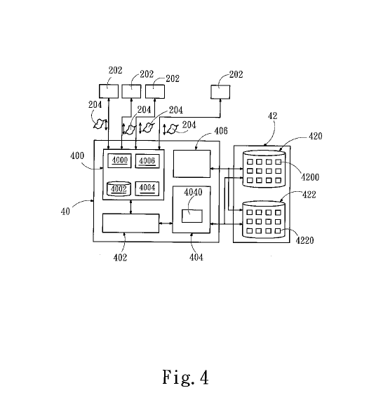

With reference to FIG. 4, a block diagram showing the share memory service system according to one preferred embodiment of the present invention includes several web services 202, which provides a specific web service for the clients required the specific web service, and every web service 202 shares the private object as a shared object with all other web services 202; a share memory service 40, which maintains the shared object and processes a request message of accessing the shared object 4200 and 4220 issuing from the web services 202; and a shared virtual memory 42, which stores the shared object 4200 and 4220.

In the embodiment, the share memory service 40 includes a session controller 400, which processes the request message 204 issuing from each of the web services 202, verifies the legality of each of the web services 202, and check a unique session ID of the request message 204; a memory binder 402, which initials the shared virtual memory 42 for the shared object newly declared, and provides the shared objects 4200 and 4220 for the web services 202; an access controller 404, which includes at least one access synchronizer 4040 for guaranteeing the concurrency control among the shared objects 4200 and 4220 and the performance of the web services 202 are correct; and a garbage collector 406, which performs the update and reuse of the shared virtual memory 42, and releases the space while the life cycle of the shared objects 4200 and 4220 terminated.

Moreover, the session controller 400 includes a web service verifier 4000, which verifies the legality of each of the web services 202 for refusing the imitated web service; a web service registry 4002, which stores an information of the legal web service 202; a UID generator 4004, which assigns the unique session ID to each of the web services 202 while the web services 202 invokes the shared memory service 40 in the first time; and a request processor 4006, which cooperates with the memory binder 402 for obtaining a default space of the shared virtual memory 42.

Furthermore, the shared virtual memory 42 includes a global shared object database 420, which stores the global shared objects 4200; and a local shared object database 422, which stores the local shared objects 4220.

In summary, the advantages of the present invention are as follows. The present invention simulates the share memory service system and method for direct data and object access of the internal and external web services instead of external calls, so as to reduce the development complexity of the enterprise application program. Moreover, the present invent is practical since the components can be implemented in the programming language such as Java, Visual Basic, C++, and so on. Furthermore, the share memory service 40 acts as a service register that differs from conventional request responder for the service requester, and hence it provides the required data and object to the service requester directly. In addition, the simplification of application developing flow may be achieved through making public and transparent to the data, object and the session context of the web service. Besides, the share memory method and system of the present invention is flexible and practical since it's adaptable to various customer requirements to either directly or indirectly interact with each other between the web services.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A share memory service system of web service oriented applications applying to a network constructed of a plurality of clients, comprising:
a plurality of web services, which provides a specific web service for the clients required the specific web service, and each of the web services shares the private object as a shared object with other web services;
a shared virtual memory, which stores the shared object; and
a share memory service, which maintains the shared object and processes a request message of accessing the shared object issuing from the web services.

2. The system of claim 1, wherein the share memory service further comprising:
a session controller, which processes the request message issuing from each of the web services, verifies the legality of each of the web services, and check a unique session ID of the request message;
a memory binder, which initials the shared virtual memory for the shared object newly declared, and provides the shared object for the web services;
an access controller, which comprises at least one access synchronizer for guaranteeing the concurrency control among the shared objects and the performance of the web services are correct; and
a garbage collector, which performs the update and reuse of the shared virtual memory, and releases the space while the life cycle of the shared object terminated.

3. The system of claim 2, wherein the session controller further comprising:
a web service verifier, which verifies the legality of each of the web services for refusing the imitated web service;
a web service registry, which stores an information of the legal web service;
a UID generator, which assigns the unique session ID to each of the web services while the web services invokes the shared memory service in the first time; and
a request processor, which cooperates with the memory binder for obtaining a default space of the shared virtual memory.

4. The system of claim 1, wherein the network is at least one selected from the group consisting of an Internet and an Intranet.

5. The system of claim 1, wherein the clients invoke the web services following a SOAP (simple object access protocol), and the request message issued from the web service having at least one SOAP.

6. The system of claim 1, wherein the web services interacts with each other through a request message comprising at least a SOAP and a session information.

7. The system of claim 1, wherein the object is at least one selected from the group consisting of a global object and a local object, and the shared object is at least one selected from the group consisting of a global shared object and a local shared object.

8. The system of claim 3, wherein the memory binder binds the shared object to the web services according to the unique session ID, and the web services, the shared memory service, the session controller, the memory binder, the access controller, the access synchronizer, the garbage collector, the web service verifier, the web service registry, the UID generator and the request processor is implemented respectively in at least one programming language selected from the group consisting of Java, Visual Basic and C++.

9. The system of claim 7, wherein the shared virtual memory further comprising:
a global shared object database, which stores the global shared object; and
a local shared object database, which stores the local shared object.

10. A share memory service method of web service oriented applications applying to a network constructed of a plurality of clients, comprising:
declaring an object requiring to be shared of a plurality of web services as a shared object;
storing the shared object to a shared virtual memory; and
providing the shared object of the shared virtual memory for the access of the web services and a plurality of clients.

11. The method of claim 10, wherein the network is at least one selected from the group consisting of an Internet and an Intranet.

12. The method of claim 10, wherein the clients invoke the web services following a SOAP (simple object access protocol), and a request message issued from the web service having at least one SOAP.

13. The method of claim 10, wherein the web services interacts with each other through a request message comprising at least a SOAP and a session information.

14. The method of claim 10, wherein the object is at least one selected from the group consisting of a global object and a local object, and the shared object is at least one selected from the group consisting of a global shared object and a local shared object.

15. The method of claim 14, wherein the shared virtual memory further comprising:
a global shared object database, which stores the global shared object; and
a local shared object database, which stores the local shared object.
